(19) United States
(12) Patent Application Publication
(10) Pub. No.: US 2009/0127447 A1
(43) Pub. Date: May 21, 2009

(54) Rotary laser with remote control

(76) Inventors: Manfred Ammann, Lauterach (AT); Andreas Winter, Feldkirch (AT); Sasha Lukic, Buchs (CH)

Correspondence Address: ABELMAN, FRAYNE & SCHWAB, 666 THIRD AVENUE, 10TH FLOOR, NEW YORK, NY, 10017, US

(21) Appl. No.: 12/313,657

(22) Filed: Nov. 20, 2008

(30) Foreign Application Priority Data
Nov. 21, 2007 (DE) 10 2007 055 439.9

(51) Int. Cl. H01J 3/14

(52) U.S. Cl. 250/236

(57) ABSTRACT

A rotary laser (1) has a laser beam unit (7) which is suitable for emitting at least one laser beam (2) rotating in a beam plane (E) and which is controlled by computer (9) so as to be switchable from a rotating operating mode (I) in which the at least one laser beam (2) rotates in the beam plane (E), to a scanning operating mode (II) in which the at least one laser beam (2) scans in the beam plane (E) within an angular sector (φ), and a plurality of detectors (10) distributed circumferentially around an axis of rotation (A) and which are sensitive to an amplitude at least within the beam plane (E) and are connected to the computer (9).

### BACKGROUND OF THE INVENTION

1. Field of the Invention

The present invention relates to a rotary laser for generating a beam plane for an at least partially revolving laser beam, and to an associated remote control for controlling this rotary laser.

2. Description of the Prior Art

Rotary lasers of this kind are used in the construction and service industries for leveling surfaces or a determined tilting of surfaces and for marking fastening points. The rotary laser, which is operated in a rotational operating mode, usually generates a complete plane in which the laser beam revolves in a uniformly rotating manner and with a constant beam intensity.

German Publication DE 100 54 627 discloses a rotary laser with an associated active beam catcher having, in addition, a remote control for the rotary laser, which remote control can be directly controlled by the user and by which the rotary laser can be controlled manually by means of buttons to tilt in two planes.

U.S. Pat. No. 3,865,491 discloses a rotary laser with an infrared receiver with which the laser beam can be oriented exactly to the position (projected within the plane of rotation) of an active beam catcher with an infrared transmitter.

German Publication DE 197 16 710 discloses a rotary laser with an active beam catcher, including an infrared transmitter which emits an infrared signal precisely when the laser beam has been detected by the beam catcher. Accordingly, the infrared signal is correlated in time with the impingement of the laser beam on the active beam catcher, so that the direction relative to the beam catcher can be determined indirectly by means of the time by the computing means in the rotary laser. The reflected infrared signal is detected by an infrared receiver in the rotary laser, whereupon this rotary laser interrupts the rotation and moves the laser beam back and forth in the angular sector around the position of the beam catcher in a scanning operating mode in order to improve the visibility of the laser beam. However, to control the rotary laser the beam catcher must be held in the rotating laser beam, which is difficult to see under unfavorable lighting conditions.

### SUMMARY OF THE INVENTION

It is the object of the present invention to realize a more robust control of a rotary laser for changing from rotating operating mode to scanning operating mode.

This and other objects of the present invention, which will become apparent hereinafter, are achieved by providing a rotary laser having a laser beam unit which is suitable for emitting at least one laser beam rotating in a beam plane and which is controlled by computing means so as to be switchable from a rotating operating mode rotating in the beam plane to a scanning operating mode which scans in the beam plane within an angular sector, and a plurality of detectors sensitive to amplitude at least within the beam plane, connected to the computing means, and distributed circumferentially around an axis of rotation.

Due to the plurality of detectors which are distributed circumferentially around an axis of rotation, the direction of a radiating transmitter (infrared, ultrasound, wireless) can be directly determined, e.g., through the amplitude distribution at the individual circumferentially distributed detectors. Accordingly, the computing means can also determine the direction of a radiating transmitter outside the beam plane and change to the scanning operating mode which swivels back and forth around the projection of the transmitter in the beam plane.

In an advantageous manner, the signal is an infrared signal, the detector is an infrared detector and the transmitter is an infrared transmitter so that the directional information can be detected in a highly accurate manner because an infrared signal is hardly deflected by diffraction.

The amplitude-sensitive detectors advantageously each have an amplitude filter which determines the amplitude of the envelope of a normally high-frequency signal so that the amplitude information is demodulated without interference.

The computing means advantageously has a maximum amplitude interpolation which interpolates the interpolation direction of the maximum amplitude from the discrete detected amplitudes of the individual detectors so that the direction of a radiating transmitter is determined through this interpolation direction.

The computing means advantageously has a maximum amplitude change interpolation which interpolates the two interpolation directions of the two maximum amplitude changes of different mathematical signs from the discrete detected amplitudes of the individual detectors so that the direction of a radiating transmitter is determined more exactly through the angle bisectors in the positive change direction between two interpolation directions.

The detectors are advantageously at a distance radially around an axis of rotation of a rotating laser beam unit so that the detectors, which do not rotate themselves, can be connected to the computing means directly (that is, without a slip ring transmitter).

In addition to forming the laser beam deflecting means (deflecting prism or plane mirror), the rotating laser beam unit advantageously forms at least one or, more advantageously, two deflecting means which are disposed on both sides of the laser beam deflecting means and which are shaped convexly perpendicular to the beam plane so that the detection sector of the detectors that is perpendicular to the beam plane is expanded, more advantageously, to a detection sector of at least 30°.

A rotary laser remote control system advantageously comprises a rotary laser of the kind mentioned above and an associated remote control with a transmitter and a transmission button which can be actuated manually for activating the signal which transmits at a constant frequency and amplitude at least over a rotation period of the rotary laser, more advantageously over several seconds.

The transmitter advantageously has a radiating solid angle in the range of 10° to 30°, more advantageously 17°, so that the user must intuitively align the remote control with the rotary laser in order to control it so that incorrect operation is minimized.

The remote control is advantageously constructed as an active beam catcher with a power source and a photodiode cell so that the laser beam can be accurately detected even under conditions of poor visibility.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a rotary laser remote control system;

FIG. 2 a plan view of a detail of the rotary laser according to FIG. 1; and

FIG. 3 a schematic view of an electrical connection diagram.

### DETAILED DESCRIPTION OF THE PREFERRED EMBODIMENT

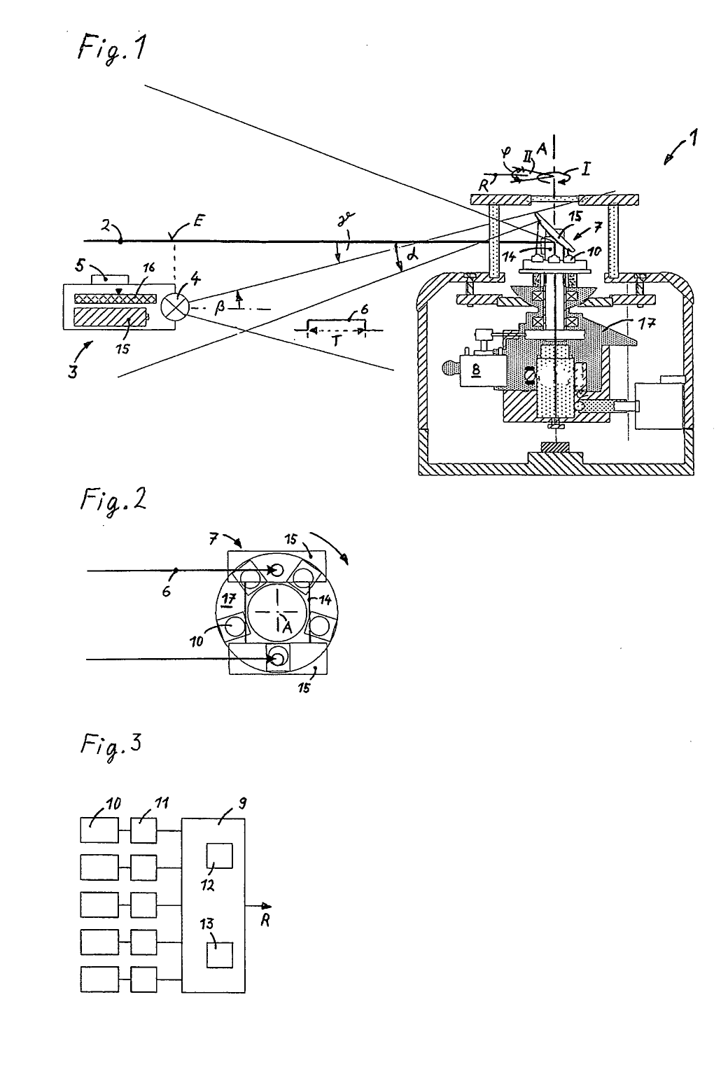

According to FIG. 1, a rotary laser remote control system includes a rotary laser 1, which emits a rotating laser beam 2 in a horizontally leveled beam plane E, and an associated remote control 3 which is arranged outside the beam plane E in viewing angle γ=10° with respect to the rotary laser 1 with an (infrared) transmitter 4 which transmits in a solid angle of β=17°. Further, the remote control 3 has a transmission button 5 that can be actuated manually for activating an (infrared) signal 6 which is emitted over the time period T=2 seconds at constant frequency and amplitude. After the (infrared) signal 6 has been received by the rotary laser 1, the latter changes from a rotating operating mode I revolving in the beam plane E to the scanning operating mode II and is swiveled back and forth within a (displayed) angular sector φ around the projection of the remote control 3 on the beam plane E. The rotary laser 1 has a laser beam unit 7 which is suitable for emitting the laser beam 2 rotating in the beam plane E and which is driven by a stepping motor 8 and is controllable by computing means 9 by means of this stepping motor 8 so as to be rotatable around an axis of rotation A. In addition to laser beam deflecting means 14 in the form of a deflecting prism, the rotating laser beam unit 7 also has two (infrared) deflecting means 15 in the form of cylindrical convex mirrors which are constructed so as to be convex perpendicular to the beam plane E for a detection sector of 2×α=30° and, as is shown in FIG. 2, are arranged on both sides of the laser beam deflecting means 14. Further, (infrared) detectors 10 (FIG. 2) are arranged parallel to the beam plane E and are connected to a swivelable leveling unit 17. The remote control 3 which is also constructed as an active beam catcher has a power source 15 and a photodiode cell 16.

According to FIG. 2, the five amplitude-sensitive (infrared) detectors 10 connected to the swivelable leveling unit 17 are arranged at a radial distance around the axis of rotation A of the rotating laser beam unit 7.

According to FIG. 3, every (infrared) detector 10 is connected by an amplitude filter 11 to the computing means 9. The computing means 9 in the form of a microcontroller has a maximum amplitude interpolation 12 which interpolates the interpolation direction of a maximum amplitude from the discrete detected amplitudes of the individual (infrared) detectors 10 and a maximum amplitude change interpolation 13 which interpolates the two interpolation directions of the two maximum amplitude changes of different mathematical signs from the detected discrete—with respect to a direction angle in the beam plane E (FIG. 1)—amplitudes of the individual (infrared) detectors 10, determines therefrom the direction R to the radiating (infrared) transmitter 4 (FIG. 1), terminates the rotating operating mode I (FIG. 1), controls the stepping motor 8 (FIG. 1) in such a way that the laser beam 2 (FIG. 1) within the beam plane E (FIG. 1) points to the transmitter 4 (FIG. 1), and then changes to the scanning operating mode II (FIG. 1).

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A rotary laser, comprising a laser beam unit (7) suitable for emitting at least one laser beam (2) rotating in a beam plane (E); computing means (9) for controlling the laser beam unit (7) and for switching same from a rotating operating mode (I) in the beam plane (E) to a scanning operating mode (II) in the beam plane (E) within an angular sector (φ); and a plurality of detectors (10) sensitive to amplitude at least within the beam plane (E), connected to the computing means (9) and distributed circumferentially around an axis of rotation (A).

2. A rotary laser according to claim 1, wherein the detectors (10) are infrared detectors.

3. A rotary laser according to claim 1, wherein the amplitude-sensitive detectors (10) each has an amplitude filter (11) which determines the amplitude of the envelope of a normally high-frequency signal (6).

4. A rotary laser according to claim 1, wherein the computing means (9) has a maximum amplitude interpolation (12) which interpolates the interpolation direction of the maximum amplitude from the discrete detected amplitudes of the individual detectors (10).

5. A rotary laser according to claim 1, wherein the computing means (9) has a maximum amplitude change interpolation (13) which interpolates the two interpolation directions of the two maximum amplitude changes of different mathematical signs from the discrete detected amplitudes of the individual detectors (10).

6. A rotary laser according to claim 1, wherein the detectors (10) are arranged at a distance radially around an axis of rotation (A) of a rotating laser beam unit (7).

7. A rotary laser according to claim 6, wherein, in addition to forming the laser beam deflecting means (14), the rotating laser beam unit (7) forms at least one deflecting means (15) shaped convexly perpendicular to the beam plane (E).

8. A rotary laser remote control system, comprising a rotary laser (1) having a laser beam unit (7) suitable for emitting at least one laser beam (2) rotating in a beam plane (E); computing means (9) for controlling the laser beam unit (7) and for switching same from a rotating operating mode (I) in the beam plane (E) to a scanning operating mode (II) in the beam plane (E) within an angular sector (φ); and a plurality of detectors (10) sensitive to amplitude at least within the beam plane (E) and is connected to the computing means (9) and distributed circumferentially around an axis of rotation (A); and an associated remote control (3) with a transmitter (4) and a transmission button (5) that can be manually actuated for activating a control signal (6) having a constant frequency and amplitude at least over a rotation period (T) of the rotary laser (1).

9. A rotary laser remote control system according to claim 8, wherein the transmitter (4) has a radiating solid angle (β) in the range of 10° to 30°.

10. A rotary laser remote control system according to claim 8, wherein the remote control is constructed as an active beam catcher with a power source and a photodiode cell.
